(19) United States
(12) Patent Application Publication
(10) Pub. No.: US 2010/0204405 A1
(43) Pub. Date: Aug. 12, 2010

(54) RELEASE FILM

(75) Inventor: Taichi Yatsuzuka, Tokyo (JP)

Correspondence Address: SMITH, GAMBRELL & RUSSELL, 1130 CONNECTICUT AVENUE, N.W., SUITE 1130, WASHINGTON, DC, 20036, US

(73) Assignee: SUMITOMO BAKELITE CO., LTD., Tokyo (JP)

(21) Appl. No.: 12/670,914

(22) PCT Filed: Jul. 14, 2008
(86) PCT No.: PCT/JP2008/062702

§ 371 Date: Jan. 27, 2010

(30) Foreign Application Priority Data
Jul. 31, 2007 (JP) 2007-198319

(51) Int. Cl. C08L 53/00

(52) U.S. Cl. 525/95

(57) ABSTRACT

There is provided a practical release film that maintains the excellent properties of a release film using syndiotactic polystyrene, and also has excellent embeddability.

There is provided a release film for manufacturing a flexible printed circuit board having a release layer comprising syndiotactic polystyrene and a hydrogenated styrene thermoplastic elastomer, characterized in that the hydrogenated styrene thermoplastic elastomer is incorporated in an amount of 15 to 35 wt % based on the total resins of the release layer. The hydrogenated styrene thermoplastic elastomer is preferably (i) a styrene-ethylene-butylene-styrene block copolymer or (ii) a styrene-ethylene-propylene-styrene block copolymer. A cyclic polyolefin type resin may be further compounded in the release layer.

### TECHNICAL FIELD

The present invention relates to a release film used in the process of manufacturing a flexible printed circuit board.

### BACKGROUND ART

A flexible printed circuit (hereinafter sometimes referred to as an FPC) is composed of a flexible circuit member in which a predetermined circuit is provided on a surface of an insulating substrate, such as a polyimide film. In manufacturing such an FPC, generally, a flexible circuit member is covered with a coverlay, a heat-resistant resin film with an adhesive, for insulation and circuit protection, a release film is laid on the coverlay, and then, they are heated and molded by a hot platen (a pressing step).

In manufacturing such an FPC, various properties are required for the release film. For example, it is necessary that (1) after hot pressing, the release film is easily peeled off from the circuit board (releasability), that (2) the release films adhering to each other on the outer peripheral portion of the circuit board are easily peeled off (low self-bonding properties), and that (3) during hot pressing, the release film conforms well to the unevenness of the circuit wires on the substrate surface and fills between the circuit wires to prevent the bleeding of the adhesive attached to the coverlay (hereinafter referred to as a coverlay adhesive), between the circuit wires (good embeddability). It is also important that part of the release film peeled off and removed after hot pressing does not attach to and contaminate the conductor portion to cause problems in the plating properties of the circuit in a subsequent step, and it is also necessary that (4) the resins compounded in the release film have good compatibility with each other. The release film used in the process of manufacturing an FPC should maintain such properties with good balance. Examples of other properties further required for the release film also include uniform pressure on the entire FPC, few appearance wrinkles in the finished FPC, no tear in the release film after use, and the like.

As one type of the release film for manufacturing an FPC, there is also one using cyclic polyolefin for the release layer, but the release film of cyclic olefin alone has the disadvantage of poor embeddability, that is, a large amount of bleeding adhesive, and the raw material cost is also high.

As other release films, release films using syndiotactic polystyrene (SPS) have also been proposed. For example, Japanese Patent No. 3850624 describes a release film comprising an outermost layer composed of a syndiotactic polystyrene layer, and a middle layer composed of syndiotactic polystyrene and/or an olefin resin (claim 1). Also, Japanese Patent Laid-Open No. 2000-38461 discloses a release film comprising a surface layer of syndiotactic polystyrene, having properties, such as crystallinity in a predetermined range. Further, Japanese Patent Laid-Open No. 2001-310428 describes a laminated film comprising a (layer A) mainly composed of syndiotactic polystyrene, a (layer B) of a styrene polymer and other thermoplastic resins, and a (layer C) mainly composed of syndiotactic polystyrene.

### Patent Document 1: Japanese Patent No. 3850624

### Patent Document 2: Japanese Patent Laid-Open No. 2000-38461

### Patent Document 3: Japanese Patent Laid-Open No. 2001-310428

### DISCLOSURE OF THE INVENTION

### Problems to be Solved by the Invention

In a release film having a release layer of syndiotactic polystyrene, among the above properties, the “embeddability” is not sufficient, and the amount of bleeding coverlay adhesive is large, and the release film does not yet have satisfactory properties as a practical release film used for manufacturing an FPC. It is an object of the present invention to provide a release film that maintains the excellent properties of a release film using syndiotactic polystyrene, and also has excellent embeddability, plating properties, and low self-bonding properties.

### Means for Solving the Problems

The present invention provides

a release film for manufacturing a flexible printed circuit board having a release layer comprising

(A) syndiotactic polystyrene and

(B) a hydrogenated styrene thermoplastic elastomer, characterized in that (B) the hydrogenated styrene thermoplastic elastomer is incorporated in an amount of 15 to 35 wt % based on the total resins of the release layer.

In the present invention, the hydrogenated styrene thermoplastic elastomer is preferably (i) a styrene-ethylene-butylene-styrene block copolymer or (ii) a styrene-ethylene-propylene-styrene block copolymer. The styrene content of the hydrogenated styrene thermoplastic elastomer is preferably 50 wt % or more.

A cyclic polyolefin type resin may be further compounded in the release layer. (i) A cyclic polyolefin polymer or (ii) a cyclic polyolefin type copolymer is used as the cyclic polyolefin type resin. The cyclic polyolefin type resin is incorporated preferably in an amount of 10 to 45 wt %, based on the total resins of the release layer. Preferably, a cushion layer is further provided on the release layer, and the release layer is on both surfaces of the cushion layer. The cushion layer should comprise a resin composition comprising an ethylene-methyl acrylate copolymer or an ethylene-methyl methacrylate copolymer as the main component.

### BEST MODE FOR CARRYING OUT THE INVENTION

A release film for manufacturing a flexible printed circuit board according to the present invention has a release layer in which (A) syndiotactic polystyrene and (B) a hydrogenated styrene thermoplastic elastomer are compounded. The resin components used in the release layer will be described below.

In the release film of the present invention,

(B) the hydrogenated styrene thermoplastic elastomer is compounded with

(A) the syndiotactic polystyrene (SPS)

in the release layer.

### (A) Syndiotactic Polystyrene (SPS)

SPS is stereospecific polystyrene which has a syndiotactic structure having alternate positioned side chains. The release film can use commercially available such polystyrene resins, for example, in the trade name XAREC S104 (manufactured by Idemitsu Kosan Co., Ltd.) and the like. The amount of SPS compounded is 25 wt % or more, preferably 41 wt % or more, based on the total resins of the outer release layer.

### (B) Hydrogenated Styrene Thermoplastic Elastomer

The hydrogenated styrene thermoplastic elastomer used in the present invention is a copolymer that is a rubber elastic body at room temperature, and refers to a partially or completely hydrogenated one. Specific examples thereof include hydrogenated products of styrene-butadiene copolymers (including all, such as random copolymers, block copolymers, and graft copolymers), more specifically, a hydrogenated styrene-ethylene-butylene-styrene copolymer (SEBS), a hydrogenated isoprene-styrene copolymer (SEP), a hydrogenated styrene-ethylene-propylene-styrene copolymer (SEPS), a hydrogenated styrene-butadiene random copolymer (HSBR), and the like.

The amount of these hydrogenated styrene thermoplastic elastomers compounded is 15 to 35 wt %, preferably 15 to 29 wt %, and more preferably 20 to 29 wt %, based on the total resins of the release layer. If the amount of these compounded is smaller than the above range, the embeddability and plating properties are not sufficient. If the amount is larger than this range, the releasability decreases, and self-bonding occurs easily.

The styrene content in the above elastomer is preferably 50 wt % or more. If the styrene content is lower than this, the releasability decreases, and self-bonding occurs easily. The upper limit value is not particularly defined as long as the object of the present invention is not impaired, but when the styrene content increases, the embeddability tends to be poor, and therefore, the styrene content is preferably appropriately selected in this range, with respected to the required embeddability and other properties.

### (C) Cyclic Polyolefin Type Resin

The cyclic polyolefin type resin used in the release film of the present invention is (i) a cyclic polyolefin polymer (COP), which is a homopolymer of cyclic olefin, and (ii) a cyclic polyolefin type copolymer (COC), which is a copolymer of cyclic polyolefins.

The cyclic polyolefin type resin is a polymer in which the main chain comprises a carbon-carbon bond and which has a cyclic hydrocarbon structure in at least part of the main chain. This cyclic hydrocarbon structure is introduced by using a monomer compound having at least one olefinic double bond in a cyclic hydrocarbon structure (cyclic olefin) as represented by norbornene and tetracyclododezone. Such cyclic polyolefin type resins include a homopolymer of cyclic polyolefin, and a copolymer of cyclic polyolefin and chain polyolefin such as ethylene.

Specific examples of the cyclic olefin used in the present invention include monocyclic olefin, such as cyclopentene, cyclohexene, cyclooctene; cyclopentadiene, and 1,3-cyclohexadiene;

bicyclic olefin, such as bicyclo[2.2.1]hepta-2-ene (trivial name: norbornene), 5-methyl-bicyclo[2.2.1]hepta-2-ene, 5,5-dimethyl-bicyclo[2.2.1]hepta-2-ene, 5-ethyl-bicyclo[2.2.1]hepta-2-ene, 5-butyl-bicyclo[2.2.1]hepta-2-ene, 5-ethylidene-bicyclo[2.2.1]hepta-2-ene, 5-hexyl-bicyclo[2.2.1]hepta-2-ene, 5-octyl-bicyclo[2.2.1]hepta-2-ene, 5-octadecyl-bicyclo[2.2.1]hepta-2-ene, 5-methylidene-bicyclo[2.2.1]hepta-2-ene, 5-vinyl-bicyclo[2.2.1]hepta-2-ene, and 5-propenyl-bicyclo[2.2.1]hepta-2-ene;

tricyclic olefin, such as tricyclo[4.3.0.12,5]deca-3,7-diene (trivial name: dicyclopentadiene), tricyclo[4.3.0.12,5]deca-3-ene; tricycle [4.4.0.12,5]undeca-3,7-diene or tricycle[4.4.0.12,5]undeca-3,8-diene or a partially hydrogenated product thereof (or an adduct of cyclopentadiene and cyclohexene), that is, tricyclo[4.4.0.12,5]undeca-3-ene; 5-cyclopentyl-bicyclo[2.2.1]hepta-2-ene, 5-cyclohexyl-bicyclo [2.2.1]hepta-2-ene, 5-cyclohexenylbicyclo[2.2.1]hepta-2-ene, and 5-phenyl-bicyclo[2.2.1]hepta-2-ene;

tetracyclic olefin, such as tetracyclo [4.4.0.12,5.17,10]dodeca-3-ene (also simply referred to as tetracyclododecene), 8-methyltetracyclo [4.4.0.12,5.17,10]dodeca-3-ene, 8-ethyltetracyclo [4.4.0.12,5.17,10]dodeca-3-ene, 8-methylidenetetracyclo [4.4.0.12,5.17,10]dodeca-3-ene, 8-ethylidenetetracyclo [4.4.0.12,5.17,10]dodeca-3-ene, 8-vinyltetracyclo[4,4.0.12,5.17,10]dodeca-3-ene, and 8-propenyl-tetracyclo [4.4.0.12,5.17,10]dodeca-3-ene; and polycyclic olefin, such as 8-cyclopentyl-tetracyclo[4.4.0.12,5.17,10]dodeca-3-ene, 8-cyclohexyl-tetracyclo[4.4.0.12,5.17,10]dodeca-3-ene, 8-cyclohexenyl-tetracyclo[4.4.0.12,5.17,10]dodeca-3-ene, 8-phenyl-cyclopentyl-tetracyclo[4.4.0.12,5.17,10]dodeca-3-ene; tetracyclo[7.4.13,6.01,9.02,7]tetradeca-4,9,11,13-tetraene (also referred to as 1,4-methano-1,4,4a,9a-tetrahydrofluorene), tetracyclo [8.4.14,7.01,10.03,8]pentadeca-5,10,12,14-tetraene (also referred to as 1,4-methano-1,4,4a,5,10,10a-hexahydroanthracene); pentacyclo[6.6.1.13,6.02,7.09,14]-4-hexadecene, pentacyclo[6.5.1.13,6.02,7.09,13]-4-pentadecene, pentacyclo[7.4.0.02,7.13,6.110,13]-4-pentadecene; heptacyclo[8.7.0.12,9.14,7.111,17.03,8.012,16]-5-eicosene, heptacyclo[8.7.0.12,9.03,8.14,7.012,17.113,16]-14-eicosene; and a tetramer of cyclopentadiene. Each of these cyclic olefins can be used alone, or two or more of these cyclic olefins can be used in combination.

Specific examples of α-olefin that can be copolymerized with cyclic olefin include ethylene or α-olefin having 2 to 20 carbon atoms, preferably 2 to 8 carbon atoms, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene, and the like. Each of these α-olefins can be used alone, or two or more of these α-olefins can be used in combination.

The method for polymerizing cyclic olefin or cyclic olefin and α-olefin, and the method for hydrogenating the obtained polymer are not particularly limited, and the polymerization and hydrogenation can be performed according to known methods in the art.

Incorporation of such a cyclic polyolefin type resin into the release layer leads an improved releasability of the film. The cyclic polyolefin type resin is incorporated in an amount of 10 to 45 wt %, preferably 10 to 30 wt %, based on the total resins of the release layer. If the content of the cyclic polyolefin type resin is larger than the above range, it leads decreasing in the embeddability, and if the content is smaller than the above range, it leads decreasing in the releasability.

### (Cushion Layer)

The release film of the present invention may be in the form of the above single-layer film, or in another form comprising a middle layer, which is a cushion layer, and the above single-layer film laminated on at least one surface of the middle layer. Such a lamination type release film has excellent cushioning properties as well as excellent releasability in hot-pressing step for a circuit board. The resin used in the cushion layer preferably has good adhesion to syndiotactic polystyrene, and is preferably a resin that has suitable cushioning properties at hot-pressing temperature and does not flow out from the end surfaces of the laminated film. Such a resin for the cushion layer preferably has a softening temperature (Vicat softening temperature) of 50 to 160° C.

If the softening temperature is less than 50° C., the resin bleeds from the end surfaces of the release film and attaches to the cauls and the like during pressing, and there is a fear of secondary contamination in the next step. On the other hand, if the softening temperature is more than 160° C., the moldability is poor, and voids may occur in the fine portions of the circuit wiring of an FPC, and therefore, such softening temperature is not preferred. The thickness of the cushion layer is not particularly limited.

Any of resin films used for such known release films in the art can be used as a material for the cushion layer, for example, α-olefin polymers, such as polyethylene and polypropylene; α-olefin type copolymers having ethylene, propylene, butene, pentene, hexene, methylpentene, and the like as copolymer components; engineering plastic resins, such as polyethersulfone and polyphenylene sulfide, and these may be used alone, or a plurality of these may be used in combination. Particularly preferred materials among these include α-olefin polymers, such as polyethylene and polypropylene; α-olefin copolymers, such as an ethylene-vinyl acetate copolymer (EVA), an ethylene-methyl acrylate copolymer (EMA), and an ethylene-methyl methacrylate copolymer (EMMA), partially ion-crosslinked products thereof, and the like.

The lamination type release film may be a two-layer release film in which a single-layer release film is laminated on one surface of a cushion layer, but is preferably a three or more-layer laminated release film having a single-layer release film on both surfaces of a cushion layer.

### (Thickness of Release Layer and Release Film)

The average thickness of the release layer of the release film is generally 15 to 50 μm, preferably 15 to 45 μm, and more preferably 15 to 30 μm, considering strength, flexibility, and adhesion. If the thickness is smaller than the above range, the release layer may tear after hot pressing, and the release layer resin may remain on the FPC surface when the FPC and the release film are peeled off. On the other hand, if the thickness exceeds the thickness in the above range, the shape conformability may decrease, and the amount of bleeding coverlay adhesive may increase.

The total thickness of the laminated release film is generally 80 μm to 200 μm, preferably 100 μm to 150 μm, considering the strength, flexibility, and adhesion of the release film. When the thickness is in this range, particularly, the balance between releasability and embeddability is excellent. The thickness of the surface layer is preferably thinner than the thickness of the cushion layer.

### (Embossing)

The release layer of the release film of the present invention should be embossed with a surface roughness (Rz: ten-point average roughness) of 3 to 20 μm, more preferably a surface roughness of 5 to 15 μm. If the surface roughness (Rz) of the release layer is less than the above range, finished appearance wrinkles after pressing occurs easily. On the other hand, if the surface roughness (Rz) is more than the above range, the coverlay adhesive may bleed from gaps in the unevenness of the circuit board and create whiskers on the sides of the circuit to bring lower plating properties.

### (Manufacture and Use of Release Film)

The method for manufacturing the release film of the present invention is not particularly limited, but a multilayer film can be manufactured with any of conventional manufacturing methods known for release films, such as a coextrusion method, an extrusion lamination method, and a dry lamination method.

The release film of the present invention obtained in this manner is used as a release film for the pressing lamination of a coverlay, as in conventional release films known in FPC manufacturing processes. The pressing step was carried out with a pressing assembly of caul/single-layer film of poly-4-methyl-1-pentene resin/cushion paper/multilayer release film/coverlay film/flexible printed circuit/single-layer film of poly-4-methyl-1-pentene resin/caul. In the pressing step, under pressure, the temperature is increased to, for example, 150 to 200° C., preferably 160 to 185° C., and this temperature is maintained for 30 to 90 minutes, preferably 45 to 80 minutes. Then, cooling to ordinary temperature is performed. During the step, the temperature increase rate is not particularly limited, but is preferably 5 to 30° C./min, particularly preferably 8 to 20° C./min. The pressurization condition also is not particularly limited, but is preferably 3 to 10 MPa, particularly preferably 4 to 6 MPa.

### EXAMPLES

The present invention will be more specifically described below by Examples and Comparative Examples. Raw materials used in the Examples and the Comparative Examples, and the properties of the raw materials are as follows.

(a) syndiotactic polystyrene (SPS):

XAREC S104 (manufactured by Idemitsu Kosan Co., Ltd.)

(b) styrene-ethylene-butylene-styrene block copolymers (SEBS):

SEPTON S8104 (manufactured by KURARAY CO., LTD.) styrene 60 wt %

SEPTON S8007 (manufactured by KURARAY CO., LTD.) styrene 30 wt %

(c) a styrene-ethylene-propylene-styrene block copolymer (SEPS)

SEPTON S2104 (manufactured by KURARAY CO., LTD.) styrene 65 wt %

(d) a cyclic polyolefin type copolymer (COC):

TOPAS 6017 (manufactured by Polyplastics Co., Ltd.)

[a copolymer of norbornene and ethylene; copolymerization ratio: 82/18 wt %]

(e) a cyclic polyolefin polymer (COP):

ZEONOR 1600 (Tg=160° C., manufactured by ZEON Corporation)

[a ring-opening polymer of a norbornene monomer]

(f) an ethylene-methyl methacrylate copolymer (EMMA):

Acryft WD105-1 (manufactured by Sumitomo Chemical Co., Ltd.)

### Examples 1 to 22 and Comparative Examples 1 to 13

### Sample Preparation

In Example 1, a release layer resin with a composition shown in Table 1 was fed to one extruder and extruded from a single-layer die (300° C.) to make a single-layer release film having a predetermined thickness. In Example 2, polymers with respective compositions shown in Table 1, as a release layer resin and a cushion layer resin, were fed to two extruders and coextruded from a two-layer die (300° C.) to make a multilayer release film having a predetermined thickness.

In Examples 3 to 22 and Comparative Examples 1 to 13, polymers with respective compositions shown in Table 1, as a release layer resin, a cushion layer resin, and a release layer resin, were fed to three extruders and coextruded from a three-layer die (300° C.) to make a multilayer release film having a predetermined thickness. For Examples 20 to 22, surface processing by off-line embossing using an embossing roll was performed to obtain surface roughness (Rz; ten-point average roughness) shown in Table 1.

The pressing step with this release film was carried out for a pressing assembly of caul/single-layer film of poly-4-methyl-1-pentene resin/cushion paper/release film/coverlay film/flexible printed circuit/single-layer film of poly-4-methyl-1-pentene resin/caul, by a single-stage press. In pressing, the temperature was increased to 170° C. at a temperature increase rate of 10° C./min under a pressurization (5 MPa) condition. Then, the temperature was maintained for 30 minutes, and then, cooling to ordinary temperature was performed. Next, this assembly was removed and evaluated.

Evaluation conformed to the JPCA standard (Performance Guide for Single- and Double-sided Flexible Printed Wiring Boards, JPCA-DG02, hereinafter abbreviated as JPCA standard) and was made with the following items and criteria. The results are shown in Table 1.

### (Evaluation Items)

### Releasability (Release Film Tear)

Releasability conformed to “JPCA standard 7.5.7.1 Attached substances on surface,” and the peeled state of the release film and the circuit board was visually evaluated after the circuit board was manufactured. The symbols are as follows. X was rejected, and the others were accepted.

| | |
|---|---|
| ⊚: tear occurrence rate | 0% |
| ◯: tear occurrence rate | less than 2.0% |
| Δ: tear occurrence rate | 2.0% or more and less |
| | than 5.0% |
| X: tear occurrence rate | 5.0% or more |

### Amount of Bleeding Coverlay Adhesive

For whether or not the bleeding of the coverlay adhesive occurred on the circuit board, the amount of the coverlay adhesive bleeding on the circuit terminal portions was evaluated in conformity with “JPCA standard 7.5.3.6 Flow of coverlay adhesive, and bleeding of covercoat.” “Embeddability” was determined by this property.

The symbols are as follows. X was rejected, and the others were accepted.

⊚: The amount of bleeding is less than 100 μm in all circuit boards.

◯: The amount of bleeding is less than 150 μm in all circuit boards.

Δ: The amount of bleeding is less than 200 μm in all circuit boards.

X: The amount of bleeding is 200 μm or more in all circuit boards.

### Low Self-Bonding Properties

For low self-bonding properties, the ease of peeling of the release films adhering to each other on the outer peripheral portion of the circuit board was evaluated after manufacturing of the circuit board.

The symbols are as follows. X was rejected, and the others were accepted.

◯: The release films are easily peeled off.

Δ: The release films can be peeled off, but they are somewhat heavy.

X: The release films can not be peeled off.

### Plating Properties

Plating properties were evaluated in conformity with “JPCA standard 7.5.4 Plating appearance (An article in which 90% or more of the required plating area is plated is a good article).” The symbols are as follows. X was rejected, and the other was accepted.

◯: Good articles are 98% or more.

X: Good articles are less than 98%.

### Appearance Wrinkles

Appearance was evaluated in conformity with “JPCA standard 7.5.7.2 Wrinkles.”

The symbols are as follows. X was rejected, and the other was accepted.

◯: The wrinkle occurrence rate is less than 2.0%.

X: The wrinkle occurrence rate is 2.0% or more.

TABLE 1
Each numerical value of raw material amount is expressed in wt %

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Release | A | SPS wt % | 72 | 65 | 72 | 80 | 85 | 32 | 40 | 48 | 40 | 70 | 64 | 64 | 56 |
| Layer | B | SEBS wt % | 28 | 35 | 28 | 20 | 15 | 28 | 20 | 32 | 30 | 20 | 26 | 16 | 24 |
| | | (Styrene60 wt %) | | | | | | | | | | | | | |
| | | SEBS wt % | | | | | | | | | | | | | |
| | | (Styrene30 wt %) | | | | | | | | | | | | | |
| | | SEPS wt % | | | | | | | | | | | | | |
| | | (Styrene65 wt %) | | | | | | | | | | | | | |
| | C | Cyclic Polyolefin | | | | | | 40 | 40 | 20 | 30 | 10 | 10 | 20 | 20 |
| | | Copolymer wt % | | | | | | | | | | | | | |
| | | (COC) | | | | | | | | | | | | | |
| | | Cyclic Polyolefin | | | | | | | | | | | | | |
| | | Polymer wt % | | | | | | | | | | | | | |
| | | (COP) | | | | | | | | | | | | | |

| | | | | | | | | | | | | | | |
|---|---|---|---|---|---|---|---|---|---|---|---|---|---|---|
| | Thickness (μm) | 20 | 20 | 20 | 20 | 20 | 20 | 20 | 20 | 20 | 20 | 20 | 20 | 20 |
| | Embossing (μm) | — | — | — | — | — | — | — | — | — | — | — | — | — |
| Cushion | EMMA wt % | — | 100 | 100 | 100 | 100 | 100 | 100 | 100 | 100 | 100 | 100 | 100 | 100 |
| Layer | Thickness (μm) | 0 | 80 | 80 | 80 | 80 | 80 | 80 | 80 | 80 | 80 | 80 | 80 | 80 |
| Eval- | Releasability | Δ | Δ | Δ | ◯ | ◯ | ◯ | ⊚ | ◯ | ◯ | ⊚ | ⊚ | ⊚ | ⊚ |
| uation | Amount of Bleeding | Δ | ⊚ | ⊚ | ⊚ | ◯ | ◯ | ◯ | ⊚ | ⊚ | ⊚ | ⊚ | ⊚ | ⊚ |
| | Adhesive | | | | | | | | | | | | | |
| | Law Self-Bonding | ◯ | Δ | ◯ | ◯ | ◯ | ◯ | ◯ | Δ | Δ | ◯ | ◯ | ◯ | ◯ |
| | Properties | | | | | | | | | | | | | |
| | Plating Properties | ◯ | ◯ | ◯ | ◯ | ◯ | ◯ | ◯ | ◯ | ◯ | ◯ | ◯ | ◯ | ◯ |
| | Appearance | ◯ | ◯ | ◯ | ◯ | ◯ | ◯ | ◯ | ◯ | ◯ | ◯ | ◯ | ◯ | ◯ |
| | Wrinkles | | | | | | | | | | | | | |

| | | | | | | | | | | | | Comparative | | |
|---|---|---|---|---|---|---|---|---|---|---|---|---|---|---|
| | | | Example | | | | | | | | | Example | | |
| | | | 14 | 15 | 16 | 17 | 18 | 19 | 20 | 21 | 22 | 1 | 2 | 3 |
| Release | A | SPS wt % | 48 | 80 | 40 | 40 | 80 | 70 | 40 | 40 | 40 | 100 | 88 | 64 |
| Layer | B | SEBS wt % | 22 | | | 20 | | 20 | 30 | 30 | 30 | 0 | 12 | 36 |
| | | (Styrene60 wt %) | | | | | | | | | | | | |
| | | SEBS wt % | | | | | 20 | | | | | | | |
| | | (Styrene30 wt %) | | | | | | | | | | | | |
| | | SEPS wt % | | 20 | 30 | | | | | | | | | |
| | | (Styrene65 wt %) | | | | | | | | | | | | |
| | C | Cyclic Polyolefin | 30 | | 30 | | | | 30 | 30 | 30 | | | |
| | | Copolymer wt % | | | | | | | | | | | | |
| | | (COC) | | | | | | | | | | | | |
| | | Cyclic Polyolefin | | | | 40 | | 10 | | | | | | |
| | | Polymer wt % | | | | | | | | | | | | |
| | | (COP) | | | | | | | | | | | | |

| | | | | | | | | | | | | | |
|---|---|---|---|---|---|---|---|---|---|---|---|---|---|
| | Thickness (μm) | 20 | 20 | 20 | 20 | 20 | 20 | 20 | 20 | 20 | 20 | 20 | 20 |
| | Embossing (μm) | — | — | — | — | — | — | 5 | 10 | 15 | — | — | — |
| Cushion | EMMA wt % | 100 | 100 | 100 | 100 | 100 | 100 | 100 | 100 | 100 | 100 | 100 | 100 |
| Layer | Thickness (μm) | 80 | 80 | 80 | 80 | 80 | 80 | 80 | 80 | 80 | 80 | 80 | 80 |
| Eval- | Releasability | ⊚ | ◯ | ◯ | ⊚ | Δ | ⊚ | ⊚ | ⊚ | ⊚ | Δ | ⊚ | Δ |
| uation | Amount of Bleeding | ⊚ | ⊚ | ⊚ | ◯ | ⊚ | ⊚ | ⊚ | ⊚ | ◯ | X | X | ⊚ |
| | Adhesive | | | | | | | | | | | | |
| | Law Self-Bonding | ◯ | ◯ | Δ | ◯ | ◯ | ◯ | Δ | Δ | Δ | ◯ | ◯ | X |
| | Properties | | | | | | | | | | | | |
| | Plating Properties | ◯ | ◯ | ◯ | ◯ | ◯ | ◯ | ◯ | ◯ | ◯ | ◯ | ◯ | ◯ |
| | Appearance | ◯ | ◯ | ◯ | ◯ | ◯ | ◯ | ◯ | ◯ | ◯ | ◯ | ◯ | ◯ |
| | Wrinkles | | | | | | | | | | | | |

| | | | Comparative | | | | | | | | | |
|---|---|---|---|---|---|---|---|---|---|---|---|---|
| | | | Example | | | | | | | | | |
| | | | 4 | 5 | 6 | 7 | 8 | 9 | 10 | 11 | 12 | 13 |
| Release | A | SPS wt % | 58 | 48 | 56 | 24 | 32 | 40 | 48 | 40 | 56 | 24 |
| Layer | B | SEBS wt % | 42 | 12 | 14 | 36 | 38 | 40 | 42 | 60 | | |
| | | (Styrene60 wt %) | | | | | | | | | | |
| | | SEBS wt % | | | | | | | | | | |
| | | (Styrene30 wt %) | | | | | | | | | | |
| | | SEPS wt % | | | | | | | | | 14 | 36 |
| | | (Styrene65 wt %) | | | | | | | | | | |
| | C | Cyclic Polyolefin | | 40 | 30 | 40 | 30 | 20 | 10 | | 30 | 40 |
| | | Copolymer wt % | | | | | | | | | | |
| | | (COC) | | | | | | | | | | |
| | | Cyclic Polyolefin | | | | | | | | | | |
| | | Polymer wt % | | | | | | | | | | |
| | | (COP) | | | | | | | | | | |

| | | | | | | | | | | | |
|---|---|---|---|---|---|---|---|---|---|---|---|
| | Thickness (μm) | 20 | 20 | 20 | 20 | 20 | 20 | 20 | 20 | 20 | 20 |
| | Embossing (μm) | — | — | — | — | — | — | — | — | — | — |
| Cushion | EMMA wt % | 100 | 100 | 100 | 100 | 100 | 100 | 100 | 100 | 100 | 100 |
| Layer | Thickness (μm) | 80 | 80 | 80 | 80 | 80 | 80 | 80 | 80 | 80 | 80 |
| Eval- | Releasability | Δ | ⊚ | ⊚ | Δ | Δ | Δ | Δ | Δ | ⊚ | Δ |
| uation | Amount of Bleeding | ⊚ | ◯ | ◯ | ◯ | ⊚ | ⊚ | ⊚ | ⊚ | ◯ | ◯ |
| | Adhesive | | | | | | | | | | |
| | Law Self-Bonding | X | ◯ | ◯ | X | X | X | X | X | ◯ | X |
| | Properties | | | | | | | | | | |
| | Plating Properties | ◯ | X | X | ◯ | ◯ | ◯ | ◯ | ◯ | X | ◯ |
| | Appearance | ◯ | ◯ | ◯ | ◯ | ◯ | ◯ | ◯ | ◯ | ◯ | ◯ |
| | Wrinkles | | | | | | | | | | |

### INDUSTRIAL APPLICABILITY

The release film comprising syndiotactic polystyrene shows excellent properties, such as completely preventing the bleeding of the coverlay adhesive during hot pressing in an FPC manufacturing process.

1. A release film for manufacturing a flexible printed circuit board having a release layer comprising
(A) syndiotactic polystyrene and
(B) a hydrogenated styrene thermoplastic elastomer, characterized in that (B) the hydrogenated styrene thermoplastic elastic elastomer is incorporated in an amount of 15 to 35 wt % based on the total resins of the release layer.

2. The release film according to claim 1, wherein (B) the hydrogenated styrene thermoplastic elastomer is
(i) a styrene-ethylene-butylene-styrene block copolymer or
(ii) a styrene-ethylene-propylene-styrene block copolymer.

3. The release film according to claim 1, wherein the styrene content of the hydrogenated styrene thermoplastic elastomer is 50 wt % or more.

4. The release film according to any of claims 1 to 3, and 6, wherein (C) a cyclic polyolefin type resin is further incorporated in the release layer.

5. The release film according to claim 4, wherein the cyclic polyolefin type resin is incorporated in an amount of 10 to 45 wt % based on the total resins of the release layer.

6. The release film according to claim 2, wherein the styrene content of the hydrogenated styrene thermoplastic elastomer is 50 wt % or more.
